(19) United States
(12) Patent Application Publication
(10) Pub. No.: US 2007/0020464 A1
(43) Pub. Date: Jan. 25, 2007

(54) Composite components, in particular bodywork parts

(75) Inventors: Thomas Droege, Neustadt (DE); Jurgen Boss, Nordhorn (DE); Stefanie Lunne, Rahden (DE); Berend Eling, Lemforde (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/569,978

(22) PCT Filed: Aug. 27, 2004
(86) PCT No.: PCT/EP04/09571

§ 371 Date: Feb. 28, 2006

(30) Foreign Application Priority Data
Sep. 1, 2003 (DE) 103 40 541.0

(51) Int. Cl. B32B 15/08; B32B 27/40; B32B 37/00

(52) U.S. Cl. 428/425.8; 428/457; 156/307.7

(57) ABSTRACT

The invention relates to composite components with the following layered structure: (i) between 0.05 mm and 2 mm metal; (ii) between 0.1 mm and 2 mm polyisocyanate-polyaddition products, which are present in a support; (iii) between 0.05 mm and 2 mm metal.

The invention relates to composite elements, for example for automotive construction or, for example, as cladding elements in buildings, in particular bodywork parts in automobiles, in trucks, in railways, in ships, or in aircraft, preferably bodywork parts in automobiles or in trucks, having the following layer structure:
(i) from 0.05 to 2 mm, preferably from 0.1 to 0.5 mm, of metal,
(ii) from 0.1 to 2 mm, preferably from 0.3 to 1.2 mm, of polyisocyanate polyaddition products, preferably polyurethanes, which may, where appropriate, have isocyanurate structures and/or urea structures, and whose storage modulus to DIN EN ISO 6721, preferably measured by the torsion pendulum method, is preferably from 60 to 350 MPa at temperatures of from −20 to +80° C., and/or whose storage modulus to DIN EN ISO 6721, preferably measured by the torsion pendulum method, is at least 1.7 MPa at temperatures of from +160 to +220° C., preferably obtainable via solvent-free reaction of (a) isocyanates and (b) compounds reactive toward isocyanates, preferably in contact with the layers (i) and (iii), preferably in contact with the layers (i) and (iii), where these are present in a carrier material, which preferably is not a polyisocyanate polyaddition product, and preferably adhesive-bond the layer (i) to the layer (iii) and to the carrier material,
(iii) from 0.05 to 2 mm, preferably from 0.1 to 0.5 mm, of metal.

The invention further relates to a process for producing these composite elements, in particular bodywork parts in automobiles, in trucks, or in aircraft, or else doors of automobiles, wheel surrounds, roofs for automobiles, engine covers for automobiles, tailgates for automobiles, outer skins for aircraft, or non-load-bearing cladding for shipbuilding, comprising the abovementioned layer structure of the invention.

Automotive construction uses steel, for example for the bodyworks, because it has excellent mechanical properties. A disadvantage of steel is that it is heavy. An example of an alternative used in place of steel is aluminum, which is lighter, but has poorer mechanical properties and is more expensive.

Alongside straight metal designs, composite elements are also known in automotive construction.

EP-A 500 376 describes the use of a metal/plastic/metal composite for vibration damping, the thickness of the steel being from 0.2 to 2 mm, and the thickness of the plastic being from 0.02 to 0.15 mm. The plastic is produced from prepolymers.

U.S. Pat. No. 4,859,523 describes the use of a steel/plastic/steel composite, the plastic being a polyurethane based on a polyesterdiol and having a glass transition temperature of from 0 to 70° C. In both specifications, the plastic layer has a glass transition temperature below 70° C. This low glass transition temperature, the significance of which is in particular pointed out in U.S. Pat. No. 4,859,523, leads to low hardness and, especially at high temperatures, to difficulties in the processing of the composite elements. The manufacture of the composite elements as in EP-A 500 376 and U.S. Pat. No. 4,859,523 by preparing the plastic layer in a solvent with subsequent drying on the metal layer is also complicated and problematic, due to the use of solvents.

DE-A 101 58 491 discloses metal/polyurethane laminates whose production may, by way of example, take place continuously via charging of the starting components for preparing the polyurethane layer between the metallic outer layers.

There is a need for improvement in these known composite elements, in particular in the process for their production. Since the starting components for preparing the polyurethane layer have to be introduced in liquid form between the outer layers, escape through the sides can lead not only to loss of starting materials but also to defects consisting of incompletely filled regions between the outer layers.

It is an object of the present invention, therefore, to develop a new composite material which in particular is accessible via a reliable and simple production process.

We have found that this object is achieved by way of the composite elements described at the outset.

A feature of the inventive composite elements is that the polyisocyanate polyaddition product, in particular polyurethane, of the layer (ii) is present in a carrier material. For the purposes of the present invention, the expression “present in a carrier material” means that the carrier material is a material which has been penetrated, i.e. saturated, at least to some extent and preferably completely, by the polyisocyanate polyaddition product. The carrier material is therefore present in the polyisocyanate polyaddition product, and the polyisocyanate polyaddition product is present in the carrier material. The use of the carrier material provides the important advantage that the liquid starting components for preparing the polyisocyanate polyaddition products are fixed in the carrier material, thus making it possible to inhibit escape in the form of runs or drips. The polyisocyanate polyaddition products preferably adhesive-bond the layer (ii) to the layer (i) and the layer (iii).

The composite elements of the invention are lightweight, sound-deadening, and stable during the paint-stoving process. In addition, the composite elements have high stiffness, even at temperatures of 200° C. The excellent adhesion of the polyurethane to the metal on the one hand, and the excellent tensile strain at break of the polyurethane, more than 30%, preferably more than 50%, particularly preferably more than 100%, on the other hand permit the composite to be used on the conventional machinery (such as presses) for processing steel, e.g. in automotive construction, e.g. for cold-forming, either before or after it has been exposed to high temperatures.

The layers (i) and (iii) used may comprise identical or different, preferably identical, well-known metals, e.g. aluminum, aluminum alloys, copper (surface-modified where appropriate), bronze, magnesium, magnesium alloys, steel, zinc-coated steel, stainless steel, galvanized steel, or chromed metals, e.g. chromed steel, preferably steel or steel alloys, e.g. chromium-/chromium-oxide-treated steel or tin-free steel, particularly preferably steel. The two metal layers (i) and (iii) on the two sides of the plastic may either be composed of the same material or of different materials, and they may have either the same thickness or a different thickness.

The carrier material preferably comprises fibrous and/or porous materials. This provides the advantage that the liquid starting components for preparing the polyurethane are absorbed effectively by the carrier material, and are held in place. This can inhibit escape of the material in the form of runs or drips from the carrier material. The carrier material particularly preferably comprises vegetable fibers, synthetic fibers, and/or glass fibers. Examples of vegetable fibers which may be used are cellulose, hemp fibers, sisal, coconut fibers, flax, cotton fibers. The synthetic fibers or glass fibers used may comprise well-known fibers. The carrier materials may preferably be present in the form of sheet-like structures, e.g. in the form of paper or cardboard, or else in the form of wovens or knitteds. The fibers may be present in pressed, knitted, woven, or felted form. Preference is given to carrier materials which can absorb at least 25% of their own weight of liquid starting components for preparing the polyisocyanate polyaddition products. It is also possible to use more than one, or different, carrier materials in one composite element, e.g. mixed wovens or multilayer materials, or a combination of fibers and mats, the fibers preferably being inserted continuously, as is the case in the pultrusion process. Particularly preferred carrier materials are highly porous materials which can absorb a relatively large amount of PU mixture.

The density of the layer (ii) is preferably from 800 to 1600 kg/m³, particularly preferably from 800 to 1200 kg/m³, especially from 900 to 1100 kg/m³.

The storage modulus of the layer (ii) (torsion pendulum method) is preferably from 60 to 350 MPa at temperatures of from −20 to +80° C. (to DIN EN ISO 6721), and/or at least 1.7 MPa at temperatures of from +160 to +220° C. (to DIN EN ISO 6721). The tensile strain at break of the layer (ii) to DIN EN ISO 527 is preferably greater than 30%, particularly preferably greater than 50%, in particular greater than 100%. The adhesion of the layer (ii) to the layer (i) and/or (iii) in the T-peel test is at least 30 N/cm, particularly preferably at least 50 N/cm. The glass transition temperature of the layer (ii) is preferably greater than 75° C., particularly preferably from 80 to 220° C., in particular from 80 to 150° C. The measurement of glass transition temperature is well known to the person skilled in the art and has been widely described. In this specification, the glass transition temperature is the relatively high-temperature maximum of the tan delta curve calculated from the two curves for storage modulus and loss modulus, these being measured during the torsional modulus test. These minimum requirements placed upon the sandwich and upon the elastomer are preferably also complied with after heat-aging at 200° C. for 1 h.

The invention further relates to a process for producing composite elements which have the following layer structure:
(i) from 0.05 to 2 mm of metal,
(ii) from 0.1 to 2 mm of carrier material comprising polyisocyanate polyaddition products,
(iii) from 0.05 to 2 mm of metal,
   by applying, to the carrier material, the liquid starting components for preparing the polyisocyanate polyaddition products, preferably saturating the carrier material with the liquid starting components and then placing the carrier material between the layers (i) and (iii), preferably with contact with the layers (i) and (iii), and curing the starting components for preparing the polyisocyanate polyaddition products.

A preferred process is one wherein, in a continuous process, the carrier material comprising the starting components for preparing the polyisocyanate polyaddition products, and the layers (i) and (iii) are preferably introduced into a belt system, and in this belt system the liquid starting components for preparing the polyisocyanate polyaddition products are reacted between (i) and (iii), and then, where appropriate, the composite element is trimmed to size and, where appropriate, molded in a press.

The thickness of the carrier material prior to the application of the starting components for preparing the polyisocyanate polyaddition products may preferably be greater than the thickness of the layer (ii) . This means that the carrier material comprising the starting components for preparing the polyisocyanate polyaddition products is preferably compressed to the thickness of the layer (ii) prior to and/or during the reaction of the starting components for preparing the polyisocyanate polyaddition products between the layers (i) and (iii). By virtue of the initially greater thickness of the carrier material and the subsequent compression to the desired thickness of the layer (ii), the liquid starting components for preparing the polyurethane can be distributed within the carrier material, with the result that the carrier material can be at least to some extent, preferably completely, saturated by the starting components.

Hence an example of a method for producing the composite elements unwinds the metal from rolls on a twin-belt system and processes it either continuously or in sections. A preferred continuous production process can involve introducing the metal of the layers (i) and (iii), for example at a width which is usually from 1 to 2 m, preferably from 1.4 to 1.6 m, into a belt system, for example by unwinding from appropriate rolls, preferably by a parallel method, preferably horizontally, preferably at the same velocity. The velocity at which the metal layers (i) and (iii) are passed through the belt system is preferably from 5 to 20 m/min.

The production process should preferably ensure a constant separation of the two metal layers. The carrier material is preferably passed between the metal layers which represent the layers (i) and (iii), this material being the material to which the starting components for preparing the polyisocyanate polyaddition product, in particular the polyurethane, have been applied. The wetting, or preferably saturating, of the carrier material by the liquid starting components may be achieved by way of conventional metering apparatuses, for example by way of a well-known mixing head. Examples of methods and apparatuses for distributing the liquid components here are those well-known from the production of sandwich elements using a polyurethane core, by means of belt systems. Examples of suitable metering apparatuses are static mixers, and high- and low-pressure machinery, preferably high-pressure machinery. The conveying rate may be varied as a function of the thickness of the layer (ii). To ensure complete filling of the space between (i) and (iii), the conveying rate and conveying equipment are preferably matched to the belt velocity. The machinery used is preferably low-pressure machinery, or particularly preferably high-pressure machinery, preferably with piston metering, particularly preferably with axial-piston metering, the feed tank preferably being a stirred feed tank, preferably with temperature control, and preferably with a feed tank-mixing head-feed tank circuit, the discharge rate preferably being from 1 to 30 kg/min. The starting components for preparing the polyisocyanate polyaddition products are usually mixed at a temperature of from 0 to 100° C., preferably from 20 to 60° C. The method of mixing may be mechanical by means of a stirrer or a mixing screw, but preferably uses the countercurrent principle, which is conventional in high-pressure machinery, and in which the stream of component A and that of component B, each at high pressure, meet and mix in the mixing head. It is also possible here for the stream of either of the components to have been divided. The reaction temperature, i.e. the temperature at which the reaction takes place, is usually >20° C., preferably from 50 to 150° C., depending on the thickness of the material. The composite element is particularly preferably heated to at least 100° C., in particular from 100 to 150° C., after the three layers have been combined. This may be achieved by using an oven or another radiant-heat method. As an alternative, it may also be possible to heat the flat conveyer described above.

There are therefore various ways of applying the starting components to the carrier material:

A high- or low-pressure machine may be used to mix the polyol component and the isocyanate component with one another and to apply these in the form of a liquid to the carrier material. The method of applying the reactive liquid may be application by pouring, spraying, or spreading. The mixing head may preferably undertake an oscillating movement across the carrier material during the application process. It is also possible to use a spreader head to distribute the starting components. A spreader head is well-known from the production of rigid-foam sandwich elements. To improve the distribution of the starting components, it is also possible, if required, to use what may be called a knife, which has been arranged perpendicularly to the direction of running of the carrier material and has a scraping action to remove excess starting components from the carrier material. Once the reactive liquid has been applied to the carrier material, the latter is preferably, as described above at the outset, continuously passed between the two metal layers within a twin-belt system, presses or rolls being used to bring the as yet not fully reacted composite to the desired thickness of the composite. If use is made of more than one pair of rollers, each of the rollers may have identical or different separation from the others, and the separation of the rollers preferably becomes smaller with each subsequent pair of rollers. For more effective reaction of the reactive starting components for preparing the polyisocyanate polyaddition products, the belt system, preferably a twin-belt system, may have a temperature-controllable region. The composite element may then be molded in a press, preferably subjected to cold forming.

The surfaces of (i) and (iii) may have been coated or, prior to the production of the composite elements, roughened, in order to clean the materials and increase their surface roughness. Those surfaces of (i) and (iii) to which (ii) is intended to adhere are preferably free from inorganic and/or organic substances which reduce adhesion, examples being dust, dirt, oils, and fats, and from substances well known as mold-release agents. To improve the adhesion between polyurethane and metal, such as steel, the steel surface may moreover be pre-treated, e.g. by corona or flame treatment, or coating with an adhesion promoter.

Suitable belt systems are well known and commercially available, and are well known, for example, for producing rigid polyurethane foam sandwich elements.

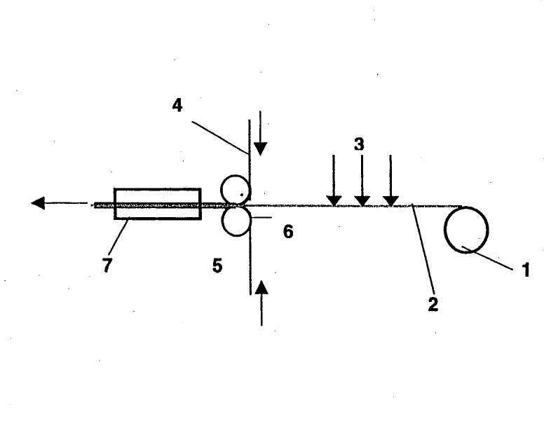

The inventive process is shown by way of example in FIG. 1, where the abbreviated references have the following meanings:
1: wound-up carrier material
2: carrier material
3: liquid starting components for preparing the polyurethane
4: steel (layer (i))
5: steel (layer (iii))
6: rolls/presses
7: heating system

The forming of the composite element preferably takes place after the liquid starting components have completed the reaction to give polyisocyanate polyaddition products (ii) or after the adhesive-bonding procedure to generate the adhesive bond between the layers (i) and (ii) or, respectively, (ii) and (iii) has been concluded. Conventional presses can be used to mold or form the composite element at temperatures of from 5 to 50° C., preferably from 10 to 35° C. Another term conventionally used for forming of the composite element at these temperatures is “cold-forming”. Because the material used as layer (ii) is flexible, and because (ii) has good adhesion to (i) and (iii), there is usually no release of the layer (ii) from (i) or (iii) during this molding process.

That surface of the composite elements produced according to the invention which is visible during use is preferably painted by conventional methods using well-known paints, and a conventional paint structure with primer etc. may be selected here. The paint may preferably be dried at a temperature of at least 200° C. The advantage of the system of the invention is specifically apparent during this further processing of the bodywork parts of the invention by molding in the press, since the system is stable even at high temperatures and no deformation of the composite element occurs at temperatures of 200° C.

The liquid for preparing the polyisocyanate polyaddition products preferably comprises (a) isocyanates and (b) compounds reactive toward isocyanates. In this specification, the terms “starting materials” and “starting compounds” in particular mean (a) isocyanates and (b) compounds reactive toward isocyanates, but, where appropriate, where these are used, also mean (c) gases, (d) catalysts, (e) auxiliaries, and/or (f) blowing agents.

The polyisocyanate polyaddition products (ii) of the invention, usually polyurethanes, which may, where appropriate, have urea structures and/or isocyanurate structures, may be prepared by the well-known reaction of (a) isocyanates with (b) compounds reactive toward isocyanates, where appropriate in the presence of (f) blowing agent(s), and where appropriate from 1 to 50% by volume, based on the volume of the polyisocyanate polyaddition products, of at least one gas (c), and of catalysts (d), and/or of auxiliaries (e). It is preferable to use blowing agents (f) instead of gases (c).

The polyisocyanate polyaddition products (ii) are preferably prepared by reacting (a) isocyanates with (b) compounds reactive toward isocyanates, where appropriate in the presence of catalysts (d), of auxiliaries (e), and/or of blowing agents (f), and in the absence of solvents. The term “solvent” means in particular well-known organic compounds, in particular those which are inert toward (a) and (b) and which, after reaction of (a) with (b), are removed from the reaction product, e.g. organic compounds whose boiling point is from 50 to 170° C. at a pressure of 1 bar.

The starting materials (a), (b), (c), (d), (e), and (f) for the process of the invention are described by way of example below:

Isocyanates (a) which may be used are the aliphatic, cycloaliphatic, araliphatic and/or aromatic isocyanates known per se, preferably diisocyanates which, where appropriate, may have been biuretized and/or isocyanuratized by well-known processes. Individual examples are: alkylene diisocyanates having from 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate, lysine ester diisocyanates (LDI), hexamethylene 1,6-diisocyanate (HDI), cyclohexane 1,3- and/or 1,4-diisocyanate, hexahydrotolylene 2,4- and 2,6-diisocyanate, and also the corresponding isomer mixtures, dicyclohexylmethane 4,4′-, 2,2′- and 2,4′-diisocyanate, and also the corresponding isomer mixtures, 1-isocyanato-3,3,5-trimethyl-5-isocyanatomethylcyclohexane (IPDI), tolylene 2,4- and/or 2,6-diisocyanate (TDI), diphenylmethane 4,4′-, 2,4′- and/or 2,2′-diisocyanate (MDI), polyphenyl polymethylene polyisocyanates, and/or mixtures comprising at least two of the isocyanates mentioned. The process of the invention may also use di- and/or polyisocyanates containing ester groups, urea groups, allophanate groups, carbodiimide groups, uretdione groups and/or urethane groups. It is preferable to use 2,4′-, 2,2′-, and/or 4,4′-MDI and/or polyphenyl polymethylene polyisocyanates, particularly preferably mixtures comprising polyphenyl polymethylene polyisocyanates and at least one of the MDI isomers.

Examples of compounds (b) which may be used and are reactive toward isocyanates are those in which the groups reactive toward isocyanates are hydroxyl, thiol and/or primary and/or secondary amino, usually those having a molar mass of from 60 to 10000 g/mol, e.g. polyols selected from the group consisting of polymer polyols, polyether polyalcohols, polyester polyalcohols, polythioether polyols, polyacetals containing hydroxyl groups and aliphatic polycarbonates containing hydroxyl groups, and mixtures of at least two of the polyols mentioned. The functionality of these compounds, which are well known to the skilled worker, toward isocyanates is usually from 2 to 6 and their molecular weight is usually from 400 to 8000.

Examples of polyether polyalcohols are those obtainable using known technology by adding alkylene oxides, such as tetrahydrofuran, propylene 1,3-oxide, butylene 1,2- or 2,3-oxide, styrene oxide, or preferably ethylene oxide and/or propylene 1,2-oxide, to conventional starter substances. Examples of starter substances which may be used are known aliphatic, araliphatic, cycloaliphatic and/or aromatic compounds containing at least one, preferably from 2 to 4, hydroxyl group(s) and/or at least one, preferably from 2 to 4, amino group(s). Examples of compounds which may be used as starter substances are ethanediol, diethylene glycol, 1,2- or 1,3-propanediol, 1,4-butanediol, 1,5-pentanediol, 1,6-hexanediol, 1,7-heptanediol, glycerol, trimethylolpropane, neopentyl glycol, sugars, such as sucrose, pentaerythritol, sorbitol, ethylenediamine, propanediamine, neopentanediamine, hexamethylenediamine, isophoronediamine, 4,4′-diaminodicyclohexylmethane, 2-(ethylamino)ethylamine, 3-(methylamino)propylamine, diethylenetriamine, dipropylenetriamine and/or N,N′-bis(3-aminopropyl)ethylenediamine.

The alkylene oxides may be used individually or alternating in succession, or as mixtures. Preference is given to the use of alkylene oxides which give primary hydroxyl groups in the polyol. Particular preference is given to the use of polyols which have been alkoxylated with ethylene oxide at the end of the alkoxylation and therefore have primary hydroxyl groups.

The polymer polyols used are a specific class of polyether polyols and may be compounds well known from polyurethane chemistry, preferably styrene-acrylonitrile graft polyols. The specific use of polymer polyols can markedly reduce the shrinkage of the polyisocyanate polyaddition product, for example of the polyurethane, and thus give better adhesion of (ii) to (i) and (iii). Other measures which may, where appropriate, be used to reduce shrinkage are the use preferably of blowing agents (f), and/or of gases (c).

One way of preparing suitable polyester polyols is to start from organic dicarboxylic acids having from 2 to 12 carbon atoms, preferably aliphatic dicarboxylic acids having from 4 to 6 carbon atoms, and from polyhydric alcohols, preferably diols, having from 2 to 12 carbon atoms, preferably from 2 to 6 carbon atoms. The polyester polyols preferably have a functionality of from 2 to 4, in particular from 2 to 3, and a molecular weight of from 480 to 3000, preferably from 600 to 2000 and in particular from 600 to 1500.

The composite elements of the invention are preferably produced using polyether polyalcohols as component (b) for reaction with the isocyanates, advantageously those with an average functionality toward isocyanates of from 1.5 to 8, preferably from 2 to 6, and with a molecular weight of from 400 to 8000.

The use of polyether polyalcohols offers considerable advantages by way of improved resistance of the polyisocyanate polyaddition products to hydrolytic cleavage, and through their lower viscosity, in each case compared with polyester polyalcohols. The improved resistance to hydrolysis is particularly advantageous for use in the automotive exteriors sector. The lower viscosity of the polyether polyalcohols and of the reaction mixture for preparing (ii) comprising the polyether polyalcohols permits simpler and more rapid charging of the space between (i) and (iii) with the reaction mixture for producing the composite elements.

In addition to the abovementioned compounds with a usual molecular weight of from 400 to 8000, other compounds which are reactive toward isocyanates and which may be used, where appropriate, as chain extenders and/or crosslinking agents in the process of the invention are diols and/or triols with molecular weights of from 60 to <400. It may moreover prove advantageous for modifying mechanical properties, such as hardness, to add chain extenders, crosslinking agents or, where appropriate, mixtures of these. The chain extenders and/or crosslinking agents preferably have a molecular weight of from 60 to 300. Examples of possible compounds are aliphatic, cycloaliphatic and/or araliphatic diols having from 2 to 14 carbon atoms, preferably from 4 to 10 carbon atoms, for example ethylene glycol, 1,3-propanediol, 1,10-decanediol, o-, m- or p-dihydroxycyclohexane, diethylene glycol, dipropylene glycol and preferably 1,4-butanediol, 1,6-hexanediol and bis(2-hydroxyethyl)hydroquinone, triols, such as 1,2,4- and 1,3,5-trihydroxycyclohexane, glycerol and trimethylolpropane, low-molecular-weight polyalkylene oxides containing hydroxyl groups and based on ethylene oxide and/or on propylene 1,2-oxide and on the abovementioned diols and/or triols as starter molecules and/or diamines, such as diethyltoluenediamine and/or 3,5-dimethylthio-2,4-toluenediamine.

If chain extenders, crosslinking agents or mixtures of these are used for preparing the polyisocyanate polyaddition products, these are usefully used in amounts of from 0 to 30% by weight, preferably from 1 to 30% by weight, based on the weight of all of the compounds (b) used which are reactive toward isocyanates.

The use of amine-started polyether polyalcohols can also improve the curing performance of the reaction mixture for preparing (ii). The compounds (b) used, and also the other components for preparing (ii), preferably have a very low water content, in order to avoid formation of carbon dioxide via reaction of the water with isocyanate groups.

The substances used in the isocyanate components and polyol components usually have different functionalities. All of the substances with a functionality of greater than two bring about chemical crosslinking of the polyisocyanate polyaddition product (ii). According to P J Flory, Polym. J. 17, 1 (1985), for example, the average molar mass between two chemical crosslinking points of a polymer chain (Mc value) can be calculated from the functionalities and proportions by weight of the starting materials. The total amount of chemical crosslinking, preferably of the isocyanate component (A) and polyol component (B), is preferably adjusted to give an Mc value of from 900 to 2000 g/mol, in order to achieve the mechanical properties described for the polyisocyanate polyaddition product (ii). Preference is therefore given to polyisocyanate polyaddition products whose Mc value, preferably determined by the method of P J Flory, Polym. J. 17, 1 (1985), is from 900 to 2000 g/mol.

Component (c) used for preparing (ii) may be well-known compounds with a boiling point below −50° C. at a pressure of 1 bar, for example air, carbon dioxide, nitrogen, helium, and/or neon. It is preferable to use air. Component (c) is preferably inert toward component (a), particularly preferably toward components (a) and (b), i.e. the gas has hardly any, and preferably no, detectable reactivity toward (a) or (b). The use of the gas (c) differs fundamentally from the use of conventional blowing agents for producing foamed polyurethanes. Whereas conventional blowing agents (f) are used in liquid form, or in the case of gaseous physical blowing agents have solubility to levels of up to a few percent in the polyol component, and during the reaction either evaporate due to the heat generated or else, in the case of water, evolve gaseous carbon dioxide on reaction with the isocyanate groups, component (c) in the present invention is preferably gaseous before it is used, in the form of an aerosol, for example, in the polyol component.

The catalysts (d) which may be used include well-known compounds which markedly accelerate the reaction of isocyanates with the compounds reactive toward isocyanates. The total catalyst content used is preferably from 0.001 to 15% by weight, in particular from 0.05 to 6% by weight, based on the weight of all of the isocyanate-reactive compounds used. Examples of compounds which may be used are: triethylamine, tributylamine, dimethylbenzylamine, dicyclohexylmethylamine, dimethylcyclohexylamine, N,N,N′,N′- tetramethyldiaminodiethyl ether, bis(dimethylaminopropyl)urea, N-methyl- and/or N-ethylmorpholine, N-cyclohexylmorpholine, N,N,N′,N′-tetramethylethylenediamine, N,N,N′,N′-tetramethylbutanediamine, N,N,N′,N′-tetramethyl-1,6-hexanediamine, pentamethyldiethylenetriamine, dimethylpiperazine, N-dimethylaminoethylpiperidine, 1,2-dimethylimidazole, 1-azabicyclo[2.2.0]octane, 1,4-diazabicyclo[2.2.2]octane (Dabco) and alkanolamine compounds, such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, e.g. N,N′,N″-tris(dimethylaminopropyl)-s-hexahydrotriazine, iron(II) chloride, zinc chloride, lead octoate, and preferably tin salts, such as tin dioctoate, diethyltin hexoate, dibutyltin dilaurate and/or dibutyldilauryltin mercaptide, 2,3-dimethyl-3,4,5,6-tetrahydropyrimidine, tetraalkylammonium hydroxides, such as tetramethylammonium hydroxide, alkali metal hydroxides, such as sodium hydroxide, alkali metal alkoxides, such as sodium methoxide or potassium isopropoxide, and/or alkali metal salts of long-chain fatty acids having from 10 to 20 carbon atoms and, where appropriate, laterally positioned OH groups.

It has proven very advantageous to carry out the preparation of (ii) in the presence of (d) in order to accelerate the reaction.

Where appropriate, auxiliaries (e) may be incorporated into the reaction mixture for preparing the polyisocyanate polyaddition products (ii). Examples which may be mentioned are fillers, surface-active substances, dyes, pigments, flame retardants, agents to protect against hydrolysis, substances with fungistatic or bacteriostatic action, and foam stabilizers.

Examples of surface-active substances which may be used are those compounds which serve to promote the homogenization of the starting materials and which, where appropriate, are also suitable for regulating the structure of the plastics. Examples which may be mentioned are emulsifiers, such as the sodium salts of castor oil sulfates or of fatty acids, and also salts of fatty acids with amines, e.g. diethylammonium oleate, diethanolammonium stearate, diethanolammonium ricinoleate, and salts of sulfonic acids, e.g. the alkali metal or ammonium salts of dodecylbenzene- or dinaphthylmethanedisulfonic acid and ricinoleic acid. The amounts usually used of the surface-active substances are from 0.01 to 5% by weight, based on 100% by weight of all of the isocyanate-reactive compounds (b) used.

Examples of suitable flame retardants are tricresyl phosphate, tris(2-chloroethyl) phosphate, tris(2-chloropropyl) phosphate, tris(1,3-dichloropropyl) phosphate, tris(2,3-dibromopropyl) phosphate, tetrakis(2-chloroethyl) ethylenediphosphate, dimethyl methanephosphonate, diethyl diethanolaminomethylphosphonate and also commercially available halogen-containing flame-retardant polyols. Compounds other than the abovementioned halogen-substituted phosphates which may be used to render the polyisocyanate polyaddition products flame-retardant are inorganic or organic flame retardants such as red phosphorus, alumina hydrate, antimony trioxide, arsenic oxide, ammonium polyphosphate and calcium sulfate, expandable graphite, and cyanuric acid derivatives, e.g. melamine, and mixtures of at least two flame retardants, e.g. ammonium polyphosphates and melamine, and also, where appropriate, corn starch or ammonium polyphosphate, or melamine and expandable graphite and/or, where appropriate, aromatic polyesters. It has generally proven useful to use from 5 to 50% by weight, preferably from 5 to 25% by weight, of the flame retardants mentioned, based on the weight of all of the isocyanate-reactive compounds used.

For the purposes of the invention, fillers, in particular reinforcing fillers, are the usual organic or inorganic fillers known per se, reinforcing agents, weighting agents, agents for improving abrasion performance in paints, coating agents, etc. Individual examples which may be mentioned are: inorganic fillers, such as silicate minerals, for example phyllosilicates, such as antigorite, serpentine, hornblendes, amphiboles, chrisotile and talc, metal oxides, such as kaolin, aluminas, titanium oxides and iron oxides, metal salts, such as chalk, barite, and inorganic pigments, such as cadmium sulfide and zinc sulfide, and also glass. Preference is given to the use of kaolin (china clay), aluminum silicate and coprecipitates of barium sulfate and aluminum silicate, and also to natural or synthetic fibrous minerals, such as wollastonite, and short metal or glass fibers. Examples of possible organic fillers are: carbon, melamine, rosin, cyclopentadienyl resins and graft polymers, and also cellulose fibers, polyamide fibers, polyacrylonitrile fibers, polyurethane fibers, and polyester fibers based on aromatic and/or on aliphatic dicarboxylic esters, and in particular carbon fibers. The inorganic or organic fillers may be used individually or as a mixture.

It is preferable to use from 10 to 70% by weight of fillers, based on the weight of (ii), as (e) auxiliaries in preparing (ii). The fillers used preferably comprise talc, kaolin, calcium carbonate, barite, glass fibers and/or glass microbeads. The dimensions selected for the particles of the fillers are preferably such as not to impede introduction of the components for preparing (ii) into the space between (i) and (iii). The particle sizes of the fillers are particularly preferably <0.5 mm. However, the fillers may also be used as internal spacers. In this case, the diameter of the fillers corresponds to the thickness of the layer (ii). The amounts of filler used in this case are preferably only relatively small, from 1 to 25% by weight, based on the weight of (ii), in order to avoid agglutination, clumping, or agglomeration of a plurality of filler particles.

It is preferable for the fillers to be used in a mixture with the polyol component in the reaction to prepare the polyisocyanate polyaddition products.

The fillers may serve to reduce the coefficient of thermal expansion of the polyisocyanate polyaddition products, which is greater than that of steel, for example, and thus to match this coefficient to that of the steel. This is particularly advantageous for a durably strong bond between layers (i), (ii) and (iii), since it results in lower stresses between the layers when they are subjected to thermal load.

It is preferable for conventional, commercially available foam stabilizers well known to the skilled worker to be used as (e) for preparing (ii), for example well-known polysiloxane-polyoxyalkylene block copolymers, e.g. Tegostab 2219 from Goldschmidt. When preparing (ii), the proportion of these foam stabilizers is preferably from 0.001 to 10% by weight, particularly preferably from 0.01 to 10% by weight, and in particular from 0.01 to 2% by weight, based on the weight of the components (b), (e) and, if used, (d) used to prepare (ii). The use of these foam stabilizers stabilizes the component (c) in the reaction mixture for preparing (ii).

Blowing agents well known in polyurethane chemistry may be used as blowing agents (f), for example physical and/or chemical blowing agents. These physical blowing agents generally have a boiling point above −50° C., preferably from −50° C. to 49° C., at a pressure of 1 bar.

Examples of physical blowing agents are CFCs, HCFCs, HFCs, aliphatic hydrocarbons, cycloaliphatic hydrocarbons, for example in each case having from 4 to 6 carbon atoms, and mixtures of these substances, for example trichlorofluoromethane (boiling point 24° C.), chlorodifluoromethane (boiling point −40.8° C.), dichlorofluoroethane (boiling point 32° C.), chlorodifluoroethane (boiling point −9.2° C.), dichlorotrifluoroethane (boiling point 27.1° C.), tetrafluoroethane (boiling point −26.5° C.), hexafluorobutane (boiling point 24.6° C.), isopentane (boiling point 28° C.), n-pentane (boiling point 36° C.), and cyclopentane (boiling point 49° C.).

Examples of chemical blowing agents which may be used, i.e. blowing agents which use a reaction, for example with isocyanate groups, to form gaseous products, are water, compounds in which water of hydration is present, carboxylic acids, tert-alcohols, e.g. tert-butanol, and carbamates, for example the carbamates described in EP-A 1000955, in particular in lines 5 to 31 on page 2 and lines 21 to 42 on page 3, carbonates, e.g. ammonium carbonate, and/or ammonium hydrogencarbonate and/or guanidine carbamate. Water and/or carbamates are preferably used as blowing agents (f). The amount of the blowing agents (f) used is preferably sufficient to obtain the preferred density of (ii) of from 800 to 1200 kg/m³. This can be determined using simple routine experiments very familiar to the skilled worker. The amount of the blowing agents (f) used is particularly preferably from 0.05 to 10% by weight, in particular from 0.1 to 5% by weight, based in each case on the total weight of the polyisocyanate polyaddition products. It is preferable for small amounts of blowing agent to be used when an internal pressure is to be generated acting against the presses or rollers of the belt system during the production process of the invention.

By definition, the weight of (ii) corresponds to the weight of the components (a), (b) and, where appropriate, (c), (d), (e) and/or (f) used to prepare (ii).

To prepare the polyisocyanate polyaddition products of the invention, the isocyanates and the isocyanate-reactive compounds are reacted in amounts such that the ratio of equivalents of NCO groups in the isocyanates (a) to the total of the reactive hydrogen atoms in the isocyanate-reactive compounds (b) and, where appropriate, (f) is from 0.85:1 to 1.25:1, preferably from 0.95:1 to 1.15:1 and in particular from 1:1 to 1.05:1. If (ii) contains at least some isocyanurate groups, the ratio selected between NCO groups and the total of the reactive hydrogen atoms is usually from 1.5:1 to 60:1, preferably from 1.5:1 to 8:1.

The polyisocyanate polyaddition products are usually prepared by the one-shot process or by the prepolymer process, for example with the aid of static mixing or of high-pressure or low-pressure technology.

It has proven particularly advantageous to use the two-component process and to combine the compounds (b) reactive toward isocyanates, the blowing agents (f) if used, the catalysts (d) if used, and/or auxiliaries (e) in component (A) (polyol component), and preferably to mix these intimately with one another, and to use the isocyanates (a) as component (B).

Component (c) may be introduced into the reaction mixture comprising (a), (b) and, if used, (f), (d) and/or (e), and/or into the individual components described above: (a), (b), (A) and/or (B). The component which is mixed with (c) is usually liquid. It is preferable for the component to be mixed into component (b).

The mixing of the appropriate component with (c) may take place by well-known processes. For example, (c) may be introduced into the appropriate component by way of well-known feeding equipment, such as air-feeding equipment, preferably under pressure, for example from a pressure vessel or compressed by a compressor, e.g. by way of a nozzle. There is preferably substantial and thorough mixing of the appropriate components with (c), and the size of the bubbles of gas (c) in the usually liquid component is therefore preferably from 0.0001 to 10 mm, particularly preferably from 0.0001 to 1 mm. The content of (c) in the reaction mixture for preparing (ii) may be determined by way of the density of the reaction mixture using well-known measurement devices in the return line of the high-pressure machinery. The content of (c) in the reaction mixture may preferably be regulated automatically on the basis of this density, by way of a control unit. Even at very low circulation rates, the component density can be determined on-line and regulated during conventional circulation of the material within the machinery.

The composite is characterized by the following properties:

The composite element is substantially lighter than a steel sheet with comparable stiffness. Thermoforming, forming, pressing, or bending of the composite does not cause any delamination or creasing on the outer side. A component made from the composite element retains its dimensional stability even after heat-aging at 200° C. for 1 h. The composite improves vibration damping and sound-deadening, when compared with metal. To improve sound-deadening, use may also be made of fillers, such as carbon black, calcium carbonate, talc, or mica, added to one or more polymer layers. The energy absorption capability of the composite during collisions is better than that of metal. The insulating action of the composite with respect to high and low temperatures is better than that of metal.

1. A composite element comprising the following layer structure:
(i) from 0.05 to 2 mm of metal,
(ii) from 0.1 to 2 mm of polyisocyanate polyaddition products which are present in a carrier material, the carrier material being a sheet-like structure or a woven or knitted fabric, and
(iii) from 0.05 to 2 mm of metal.

2. The composite element according to claim 1, wherein the density of the layer (ii) is from 800 to 1600 kg/m³.

3. The composite element according to claim 1, wherein the tensile strain at break of the layer (ii) to DIN EN ISO 527 is greater than 30%.

4. The composite element according to claim 1, wherein the adhesion of the layer (ii) to the layer (i), the layer (iii), or the layers (i) and (iii) in the T-peel test is at least 30 N/cm.

5. The composite element according to claim 1, wherein the glass transition temperature of the layer (ii) is greater than 75° C.

6. The composite element according to claim 1, wherein the carrier material comprises fibrous materials, porous materials, or a combination thereof.

7. The composite element according to claim 1, wherein the carrier materials comprise vegetable fibers, synthetic fibers, glass fibers, or a combination thereof.

8. A method of making an article, comprising forming the article with the composite element of claim 1, wherein the article is a door for an automobile, a wheel surround, an automobile roof, an engine hood, a automobile tailgate, or an outer skin for an aircraft.

9. A process for producing composite elements which have the following layer structure:
(i) from 0.05 to 2 mm of metal,
(ii) from 0.1 to 2 mm of carrier material comprising polyisocyanate polyaddition products, the carrier material being a sheet-like structure or a woven or knitted fabric, and
(iii) from 0.05 to 2 mm of metal,
which comprises applying, to the carrier material, liquid starting components for preparing the polyisocyanate polyaddition products, placing the carrier material
between the layers (i) and (iii), and curing the starting components to prepare the polyisocyanate polyaddition products, thereby preparing the composite elements.

10. The process according to claim 9, wherein, in a continuous process, the carrier material comprising the starting components for preparing the polyisocyanate polyaddition products, and the layers (i) and (iii) are introduced into a belt system, wherein in the belt system the liquid starting components for preparing the polyisocyanate polyaddition products are reacted between (i) and (iii), and optionally, the composite element is trimmed to size and, optionally, molded in a press.

11. The process according to claim 9, wherein the thickness of the carrier material prior to the application of the starting components for preparing the polyisocyanate polyaddition products is greater than the thickness of the layer (ii).

12. The process according to claim 11, wherein, prior to, during, or prior to and during the reaction of the starting components for preparing the polyisocyanate polyaddition products between the layers (i) and (iii), the carrier material comprising the starting components for preparing the polyisocyanate polyaddition products is compressed to the thickness of the layer (ii).

13. The composite element according to claim 1, wherein the density of the layer (ii) is from 800 to 1200 kg/m³.

14. The composite element according to claim 1, wherein the density of the layer (ii) is from 800 to 1100 kg/m³.

15. The process of claim 10, comprising trimming the composite element to size.

16. The process of claim 10, comprising molding the composite element in a press.

17. The process of claim 10, comprising trimming the composite element to size and molding the composite element in a press.

18. The process according to claim 10, wherein the thickness of the carrier material prior to the application of the starting components for preparing the polyisocyanate polyaddition products is greater than the thickness of the layer (ii).

19. The process of claim 1, wherein the glass transition temperature of the layer (ii) is from 80 to 220° C.

20. The process of claim 1, wherein the glass transition temperature of the layer (ii) is from 80 to 150° C.
